(19) United States
(12) Patent Application Publication
(10) Pub. No.: US 2020/0302398 A1
(43) Pub. Date: Sep. 24, 2020

(54) DETERMINATION OF PROFILE MATCH FOR JOB POSTING

(71) Applicant: Microsoft Technology Licensing, LLC, Redmond, WA (US)

(72) Inventors: Sandeep Wali, Sunnyvale, CA (US); Xiaojing Ma, Sunnyvale, CA (US); Yusuke Takebuchi, San Jose, CA (US); Sumedha Swamy, San Jose, CA (US); Wen Pu, Santa Clara, CA (US)

(21) Appl. No.: 16/360,266

(22) Filed: Mar. 21, 2019

(51) Int. Cl. G06Q 10/10; G06N 20/00

(52) U.S. Cl. CPC G06Q 10/1053; G06N 20/00

(57) ABSTRACT

Methods, systems, and computer programs are presented for determining presentation options, associated with a job posting, related to how well the member's profile matches the job posting characteristics. One method includes performing a job search for a member of an online service that returns jobs for presentation to the member, and identifying a job posting from the job postings. The method further includes determining a job-matching score that indicates a degree of matching between a profile of the member and characteristics of the identified job. Further yet, the method checks if the job-matching score is above a matching threshold and the identified job is presented, in a user interface, with a message based on the checking. The message is based on the degree of matching between the profile of the member and the characteristics of the job.

### TECHNICAL FIELD

The subject matter disclosed herein generally relates to methods, systems, and machine-readable storage media for determining scores that indicate how a potential candidate matches requirements.

### BACKGROUND

Some online services provide job postings to their members. The member may perform a job search by entering a job search query, and the online service has to analyze thousands or millions or job postings to select the best matches for the user characteristics. Further, there could be many candidates applying for a job, or a user may be presented with hundreds or thousands of possible job postings, which makes finding the perfect job an arduous and difficult task.

Therefore, it becomes difficult for the job recruiter to find the best candidate among hundreds of applicants, and also, it becomes difficult for the job seeker to find the job that best suits their qualifications.

### BRIEF DESCRIPTION OF THE DRAWINGS

Various ones of the appended drawings merely illustrate example embodiments of the present disclosure and cannot be considered as limiting its scope.

FIG. 1 is a block diagram illustrating a networked system, according to some example embodiments.

FIG. 2 is a screenshot of a user interface that includes job postings, according to some example embodiments.

FIG. 3 is a screenshot of a member's profile view, according to some example embodiments.

FIG. 4 is a user interface for creating a job posting, according to some example embodiments.

FIG. 5 illustrates a data flow for selecting job postings to be presented to a member, according to some example embodiments.

FIG. 6 is a histogram of matching scores for members that view a job posting, according to some example embodiments.

FIG. 7 illustrate the process for determining if the qualified-job-seeker (QJS) flavor is selected for presentation in the user interface, according to some example embodiments.

FIG. 8 illustrates the training and use of a machine-learning program, according to some example embodiments.

FIG. 9 is a flowchart of a method for determining presentation options, associated with a job posting, related to how well the member's profile matches the job post characteristics.

FIG. 10 is a block diagram illustrating an example of a machine upon or by which one or more example process embodiments described herein may be implemented or controlled.

### DETAILED DESCRIPTION

Example methods, systems, and computer programs are directed to determining presentation options, associated with a job posting, related to how well the member's profile matches the job posting characteristics. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

When a job seeker searches for a job, the job seeker may have to sort through hundreds or thousands of job postings. The online service that shows the job postings may help the job seeker to apply for jobs easily, but the job seeker may have to compete with tens or hundreds of candidates that also apply for the job. In some embodiments, the online service may be a social networking service that offers utilities for posting and searching for jobs.

In order to assist the job seeker, the online service may look at different aspects, referred to herein as flavors, that assist the job seeker to identify job opportunities with a higher probability of being hired, such as having connections working at the company offering the job, analyzing the hiring patterns of the company posting the job, etc.

One of these flavors, called Qualified Jobseeker (QJS), identifies when the profile of the job seeker matches the characteristics of the job posting. The characteristics of the job posting include the requirements entered by the job poster as well as information on the company posting the job posting and other job-related parameters. The QJS flavor obtains a matching score that measures how well the profile of the member matches the characteristics of a given job posting. A message is then presented to the member indicating how well the member matches the job posting. This way, the member may focus on job postings that are good matches in order to apply for those jobs for which the member has a higher probability of getting hired.

One general aspect includes a method that includes an operation for performing a job search for a member of an online service. The job search returns job postings for being presented to the member. Further, the method includes an operation for identifying a job posting from the job postings, and an operation for determining a job-matching score that indicates a degree of matching between a profile of the member and the characteristics of the identified job posting. Further, the method includes checking if the job-matching score is above a matching threshold. Additionally, the method includes causing presentation in a user interface of the identified job posting with a message based on the checking, the message based on the degree of matching between the profile of the member and the characteristics of the identified job posting.

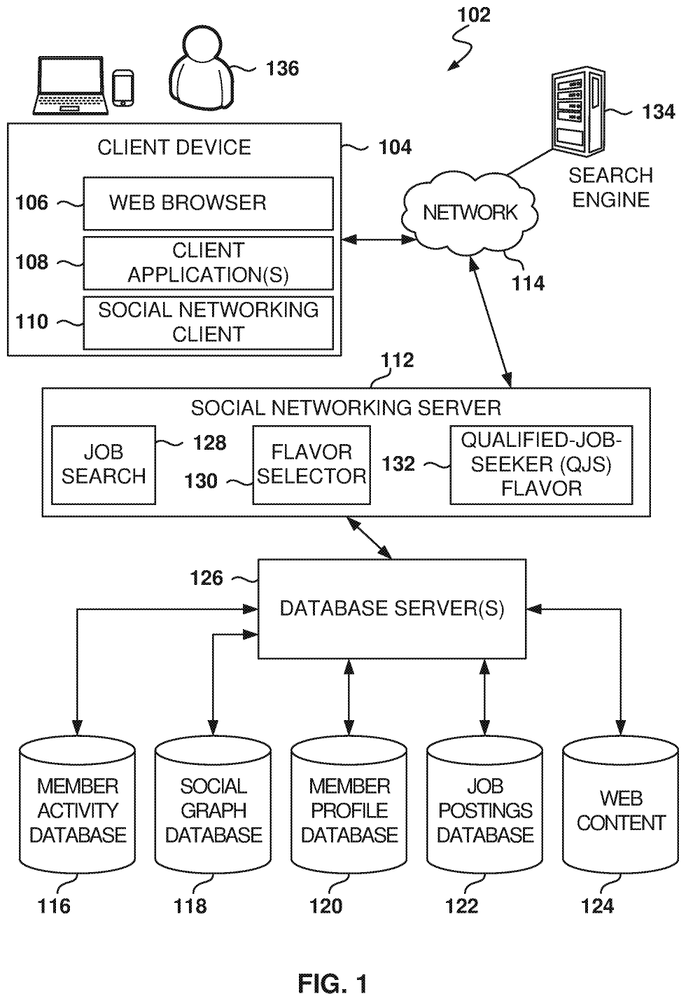

FIG. 1 is a block diagram illustrating a networked system, according to some example embodiments, including a social networking server 112, illustrating an example embodiment of a high-level client-server-based network architecture 102. Embodiments are presented with reference to an Internet service, but the principles used herein may be used for any online service accessed by members, such as a social networking service.

The social networking server 112 provides server-side functionality via a network 114 (e.g., the Internet or a wide area network (WAN)) to one or more client devices 104. FIG. 1 illustrates, for example, a web browser 106, client application(s) 108, and a social networking client 110 executing on a client device 104. The social networking server 112 is further communicatively coupled with one or more database servers 126 that provide access to one or more databases 116-124.

The client device 104 may comprise, but is not limited to, a mobile phone, a desktop computer, a laptop, a portable digital assistant (PDA), a smart phone, a tablet, a netbook, a multi-processor system, a microprocessor-based or programmable consumer electronic system, or any other communication device that a member 136 may utilize to access the social networking server 112. In some embodiments, the client device 104 may comprise a display module (not shown) to display information (e.g., in the form of user interfaces). In further embodiments, the client device 104 may comprise one or more of touch screens, accelerometers, gyroscopes, cameras, microphones, Global Positioning System (GPS) devices, and so forth.

In one embodiment, the social networking server 112 is a network-based appliance that responds to initialization requests or search queries from the client device 104. One or more members 136 may be a person, a machine, or other means of interacting with the client device 104. In various embodiments, the member 136 is not part of the network architecture 102 but may interact with the network architecture 102 via the client device 104 or another means.

The client device 104 may include one or more applications (also referred to as “apps”) such as, but not limited to, the web browser 106, the social networking client 110, and other client applications 108, such as a messaging application, an electronic mail (email) application, a news application, and the like. In some embodiments, if the social networking client 110 is present in the client device 104, then the social networking client 110 is configured to locally provide the user interface for the application and to communicate with the social networking server 112, on an as-needed basis, for data and/or processing capabilities not locally available (e.g., to access a member profile, to authenticate a member 136, to identify or locate other connected members 136, etc.). Conversely, if the social networking client 110 is not included in the client device 104, the client device 104 may use the web browser 106 to access the social networking server 112.

Further, while the client-server-based network architecture 102 is described with reference to a client-server architecture, the present subject matter is of course not limited to such an architecture, and could equally well find application in a distributed, or peer-to-peer, architecture system, for example.

In addition to the client device 104, the social networking server 112 communicates with the one or more database servers 126 and databases 116-124. In one example embodiment, the social networking server 112 is communicatively coupled to a member activity database 116, a social graph database 118, a member profile database 120, a job postings database 122, and a web content database 124. The databases 116-124 may be implemented as one or more types of databases including, but not limited to, a hierarchical database, a relational database, an object-oriented database, one or more flat files, or combinations thereof.

The member profile database 120 stores member profile information about members 136 who have registered with the social networking server 112. With regard to the member profile database 120, the member 136 may include an individual person or an organization, such as a company, a corporation, a nonprofit organization, an educational institution, or other such organizations.

In some example embodiments, when a member 136 initially registers to become a member 136 of the social networking service provided by the social networking server 112, the member 136 is prompted to provide some personal information, such as name, age (e.g., birth date), gender, interests, contact information, home town, address, spouse's and/or family members' names, educational background (e.g., schools, majors, matriculation and/or graduation dates, etc.), employment history (e.g., companies worked at, periods of employment for the respective jobs, job title), professional industry (also referred to herein simply as “industry”), skills, professional organizations, and so on. This information is stored, for example, in the member profile database 120. Similarly, when a representative of an organization initially registers the organization with the social networking service provided by the social networking server 112, the representative may be prompted to provide certain information about the organization, such as a company industry. This information may be stored, for example, in the member profile database 120.

As members 136 interact with the social networking service provided by the social networking server 112, the social networking server 112 is configured to monitor these interactions. Examples of interactions include, but are not limited to, commenting on posts entered by other members 136, viewing member profiles, editing or viewing a member 136's own profile, sharing content outside of the social networking service (e.g., an article provided by an entity other than the social networking server 112), updating a current status, posting content for other members 136 to view and comment on, posting job suggestions for the members 136, searching job postings, and other such interactions. In one embodiment, records of these interactions are stored in the member activity database 116, which associates interactions made by a member 136 with his or her member profile stored in the member profile database 120.

The job postings database 122 includes job postings offered by companies. Each job posting includes job-related information such as any combination of employer, job title, job description, requirements for the job posting, salary and benefits, geographic location, one or more job skills desired, day the job posting was posted, relocation benefits, and the like.

The web content database 124 includes web pages provided by the social networking server 112. The web content database 124 stores content items, data that is used to generate web pages of a particular web site (that may be hosted by social networking server 112), search results, and/or data about accesses to, and member interactions with, the content items.

While the database server(s) 126 are illustrated as a single block, one of ordinary skill in the art will recognize that the database server(s) 126 may include one or more such servers. Accordingly, and in one embodiment, the database server(s) 126 implemented by the social networking service are further configured to communicate with the social networking server 112.

The social networking server 112 includes, among other modules, a job search module 128, a flavor selector module 130, and QJS flavor module 132. More details regarding the functionality of this modules is provided below. Each of the modules may be implemented in software, hardware, or any combination of software and hardware.

The network architecture 102 may also include a search engine 134. Although only one search engine 134 is depicted, the network architecture 102 may include multiple search engines 134. Thus, the social networking server 112 may retrieve search results (and, potentially, other data) from multiple search engines 134. The search engine 134 may be a third-party search engine. Examples of the search engine 134 include Bing, Ask, and search engines provided by Google, Yahoo!, Baidu, and AOL.

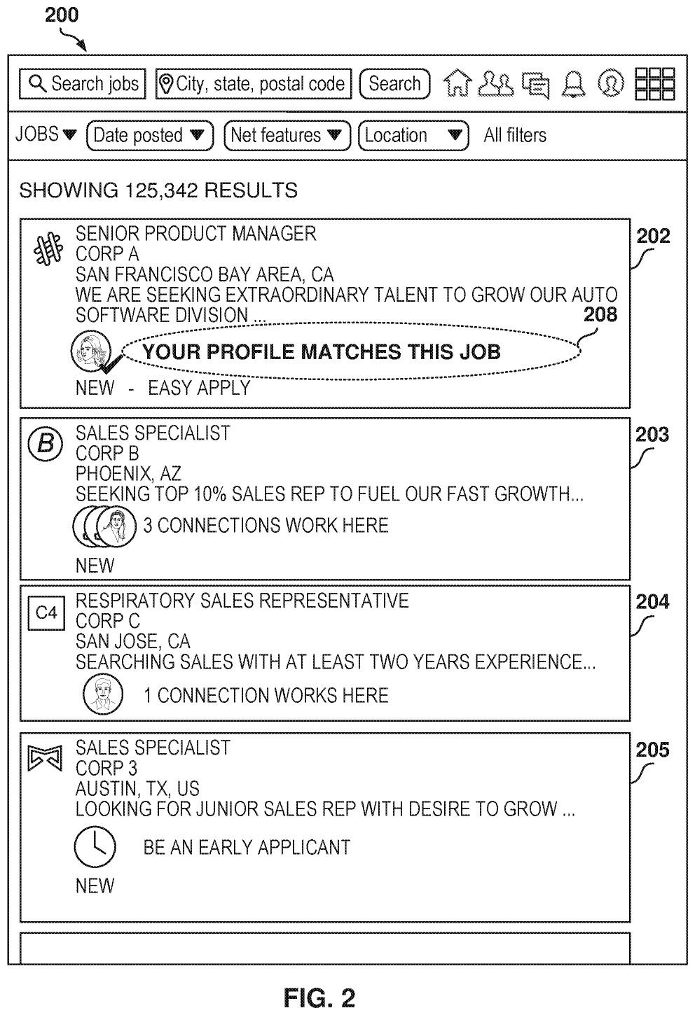

FIG. 2 is a screenshot of a user interface 200 that includes job postings 202-205, according to some example embodiments. In some example embodiments, the member 136 may enter a query to search for jobs and the results of the query are shown in the user interface 200. In other example embodiments, the online service provides job recommendations based on the profile and activities of the member 136. Although some embodiments are presented with reference to responses to job-search queries, the same principles may be applied to other scenarios where job postings 202-205 are presented to the member 136 (e.g., jobs sponsored by recruiters).

As the member 136 scrolls down the user interface 200, more job posting recommendations are presented to the member 136. In some example embodiments, the job posting recommendations are prioritized to present job postings in an estimated order of interest to the member 136.

In some example embodiments, a plurality of flavors is implemented by the job-search service. Each flavor provides an indication of a feature that is important to the member 136 for selecting from the flavor, such as how many people have transitioned from the company of the member 136 to the company offering the job, who would be a virtual team for the member 136 if the member 136 joined the company, and the like.

Another flavor includes analyzing data regarding transitions of members 136 of the social networking service from one company to another. This way, if a company is hiring a large number of workers from the company of the member 136, the member 136 will be encouraged to consider job postings 202-205 from this company, not only because the chances of landing the job will be higher than average, but also because the member 136 would join former colleagues. Another flavor indicates how the qualifications of the member 136 compare to those of other members 136 that have applied for the job posting, which indicates if the member 136 has a high probability of getting the job or being selected for an interview.

In some example embodiments, a single flavor is selected for adding the flavor information being presented for a job posting 202-205. However, other example embodiments may provide information regarding multiple flavors.

It is possible to determine whether a job seeker is a good match for a job posting by comparing the information the job seeker has provided in their profile with the targeting criteria in the job posting 202-205. A QJS flavor 132 measures a degree of matching between a member 136 and a job posting 202-205, e.g., how well the member 136 matches the characteristics of the job posting. The more job requirements that the member 136 meets, the higher the degree of matching will be. Further, the higher the degree of matching, the higher the probability that the member 136 will be hired for the job. The characteristics of the job posting include the requirements entered by the job poster as well as properties of the company hiring for that job.

Job posting 202 is a job posting for a “Senior Product Manager” at company Corp A. The job posting 202 includes summary information, such as location, all or part of the job description, and other flags, such as if the job posting is new or if there is an option for “easy apply,” which means that the process for applying to the job posting has been simplified by the online service.

Additionally, the QJS flavor 132 has identified that the member 136 is a good match for job posting 202 so a matching message 208 is also included with the job posting 202 to indicate that the member 136's profile matches the characteristics of the job posting 202. In the exemplary embodiment of FIG. 2, the matching message 208 is “Your profile matches this job,” but other embodiments may include other matching message 208 showing that the member 136 matches the job requirements, such as, “You are a great match for this job,” “Your skills and experience match the job requirements for this job,” etc.

In other example embodiments, the matching message 208 may include the matching score, such as, “Your matching score for this job is 95 out of 100,” or “Your skills have a matching score of 95 for this job.”

When doing a search, the member 136 may not necessarily enter parameters associated with the member 136's profile. For example, a member 136 with experience as a software developer may perform a search for “teacher.” The job results will be related to teaching jobs, although the software developer may not have any experience as a teacher. However, if the teaching job requires software-developer experience, the software developer may see a message that indicates that the particular teaching job is a good match for his qualifications. This way, the software developer looking at changing careers may see jobs that would be a good fit.

In some example embodiments, the QJS flavor 132 is not triggered if the matching score for the job posting 202-205 is below a certain threshold. In this case, the message associated with the QJS flavor 132 is not presented for that job posting. For example, job postings 203, 204, and 205 do not include that matching message 208.

It is noted that the embodiments illustrated in FIG. 2 are examples and do not describe every possible embodiment. Other embodiments may utilize different job-presentation lamps, include additional or less information for each job posting 202-205, etc. The embodiments illustrated in FIG. 2 should therefore not be interpreted to be exclusive or limiting, but rather illustrative.

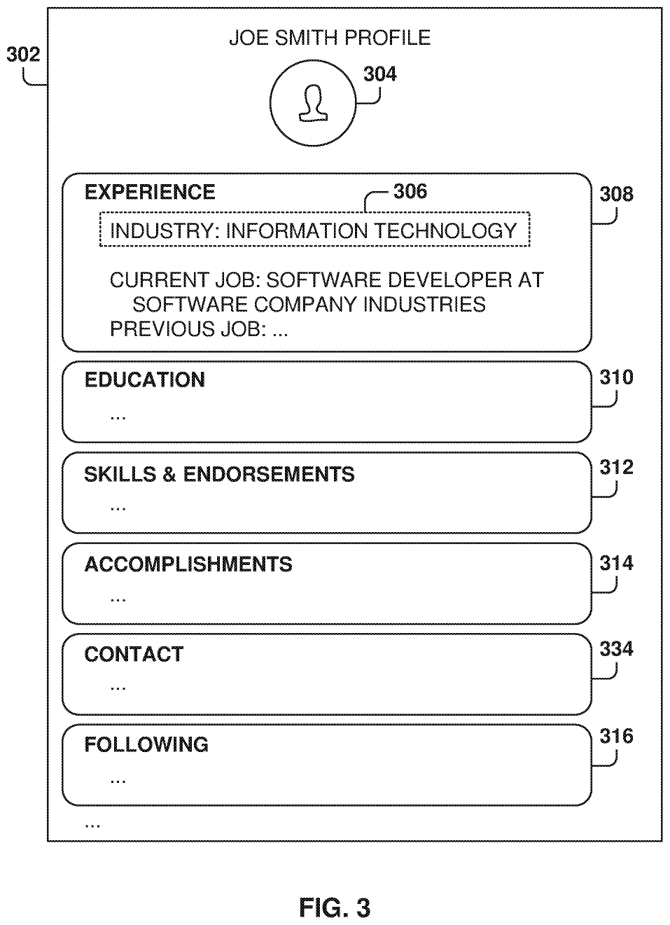

FIG. 3 is a screenshot of a member 136's profile view, according to some example embodiments. Each member 136 in the social networking service has a member profile 302, which includes information about the member (e.g., the member 136). The member profile 302 is configurable by the member 136 and also includes information based on member activity in the social networking service (e.g., likes, posts read).

In one example embodiment, the member profile 302 may include information in several categories, such as experience 308, education 310, skills and endorsements 312, accomplishments 314, contact information 334, following 316, language 320, and the like. Skills include professional competences that the member 136 has, and the skills may be added by the member 136 or by other members 136 of the social networking service. Example skills include C++, Java, Object Programming, Data Mining, Machine Learning, Data Scientist, Spanish, and the like. Other members 136 of the social networking service may endorse one or more of the skills and, in some example embodiments, the account is associated with the number of endorsements received for each skill from other members 136.

The experience 308 category of information includes information related to the professional experience of the member 136. In one example embodiment, the experience 308 information includes an industry 306, which identifies the industry in which the member 136 works. Some examples of industries configurable in the member profile 302 include information technology, mechanical engineering, marketing, and the like. The member profile 302 is identified as associated with a particular industry 306, and the posts related to that particular industry 306 are considered for inclusion in the member 136's feed, even if the posts do not originate from the member 136's connections or from other types of entities that the member 136 explicitly follows. The experience 308 information area may also include information about the current job and previous jobs held by the member 136.

The education 310 category includes information about the educational background of the member 136, including educational institutions attended by the member 136. The skills and endorsements 312 category includes information about professional skills that the member 136 has identified as having been acquired by the member 136, and endorsements entered by other members 136 of the social networking service supporting the skills of the member 136. The accomplishments 314 area includes accomplishments entered by the member 136, and the contact information 334 includes contact information for the member 136, such as email and phone number. The following 316 area includes the name of entities in the social networking service being followed by the member 136. The language 320 area includes the languages spoken by the member 136.

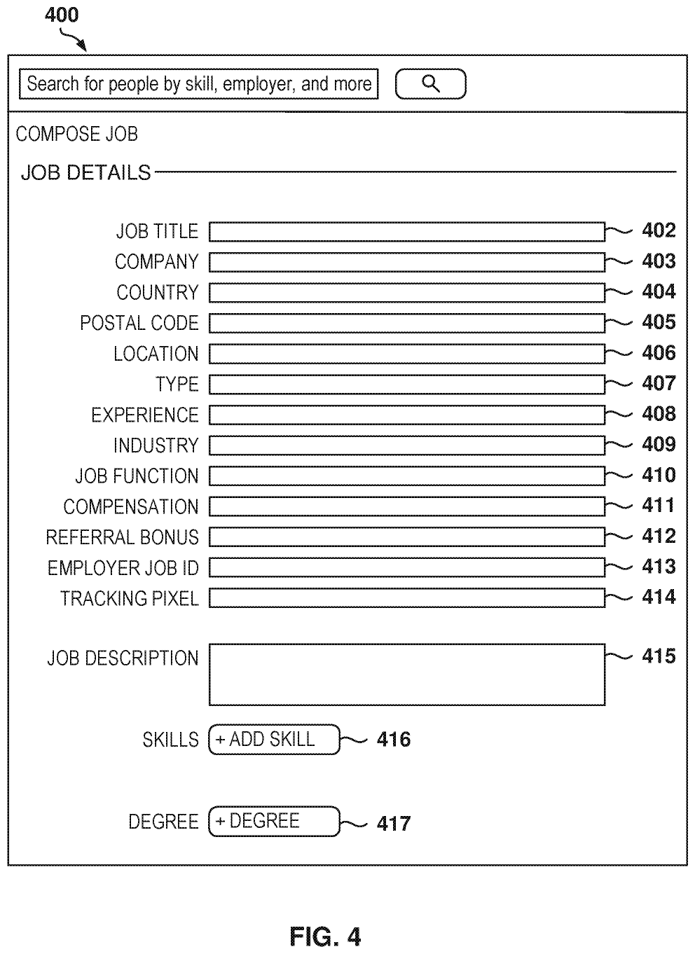

FIG. 4 is a user interface 400 for creating a job posting 202-205, according to some example embodiments. The job poster may enter data for a plurality of job posting fields 402-417. Some of the fields might be required, such as company 403, while other fields may be optional, such as compensation 411. The user interface 400 allows the job poster to fine tune the targeting of job candidates for the specific job by entering information about the job posting 202-205.

The job posting fields 402-417 include a job title 402, the company 403 hiring for the job, a country 404 where the job is located, a postal code 405 where the job is located, a location 406 (e.g., street address, city) of the job, a type 407 (e.g., full-time, part-time, contractor), experience 408 (e.g., number of years working for a similar job), an industry 409, a job function 410 (e.g., manager), a compensation 411, a referral bonus 412 offered for a referral resulting in a hire, an employer job identifier 413, a tracking pixel 414, a job description 415, zero or more skills 416, and zero or more degrees 417.

The information entered by the job poster enables fine targeting for selecting job applicants that match the characteristics of the job posting. It is noted that there may be other parameters that may not be included in the user interface 400 but that still help narrow the search for candidates. For example, the company 403 information in the online service may be used to narrow the search. If the company 403 shows that it is hiring a high percentage of graduates from a certain university, the matching score for members 136 with degrees 417 from the university will be higher than for members 136 without degrees 417 from the university.

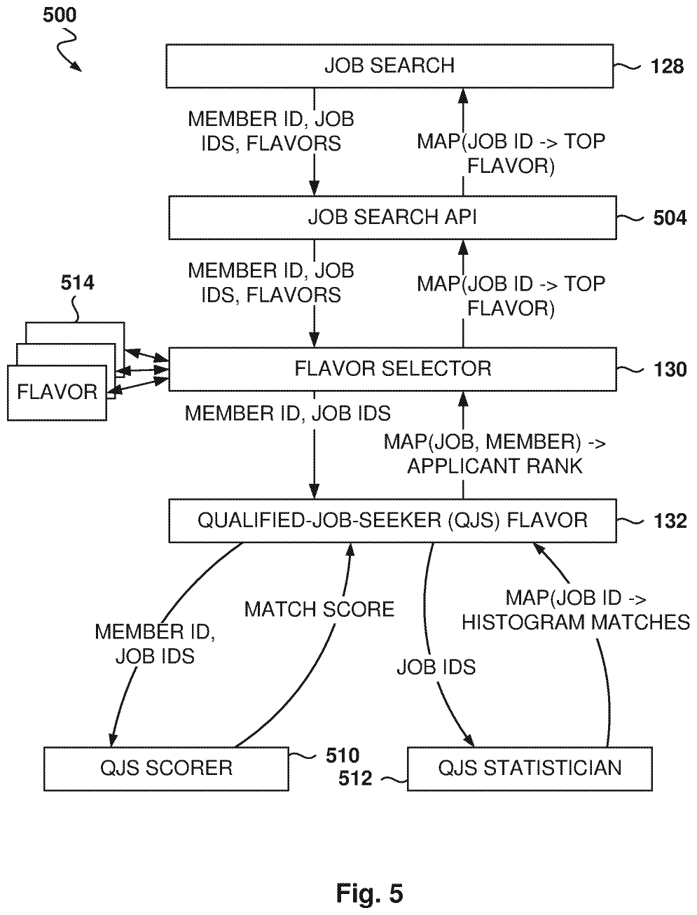

FIG. 5 illustrates a data flow for selecting job postings to be presented to a member 136, according to some example embodiments. The job search module 128 provides the user interface for job searches and interfaces with the search system of the online service that searches for job postings in that job postings database 122.

The job search application programming interface (API) 504 is the programmatic interface to the flavor selector 130. The flavor selector 130 interfaces with the different flavors 514, 132 and selects which flavor, or flavors 514, to use for each job posting 202-205 identified in the search based on the relevance of the flavor and the search. In some example embodiments, the flavor selector 130 gets a score from each of the flavors 514 selected, and the respective scores are used to select the best flavor, or flavors 514, to present.

When a flavor (e.g., QJS flavor 132, connections at the company 403) is selected by the flavor selector 130, then information related to the flavor is provided in the user interface. As discussed above, when the QJS flavor 132 is selected, a message is presented with the job posting indicated that the user is a good match for the job posting.

The QJS flavor 132 determines when the job ID is a good match for the member 136's profile based on a matching score calculated by a QJS scorer 510 and the statistics for the job ID provided by a QJS statistician 512.

For a given job posting found in the job search, the job search 128 sends the member identifier (ID) of the member 136 performing the search, the job identifiers (IDS) of the job postings found in the search, and a list of flavors 514 for consideration by the flavor selector 130. In some example embodiments, the list of flavors 514 may be omitted and the flavor selector 130 may determine which flavors 514 to use based on the relevance of each of the possible flavors 514.

The job search API 504 forwards the member ID, the job IDS, and the list of flavors 514 to the flavor selector 130. The flavor selector 130 then forwards the member ID and the job IDs to the selected flavors 514, such as the QJS flavor 132.

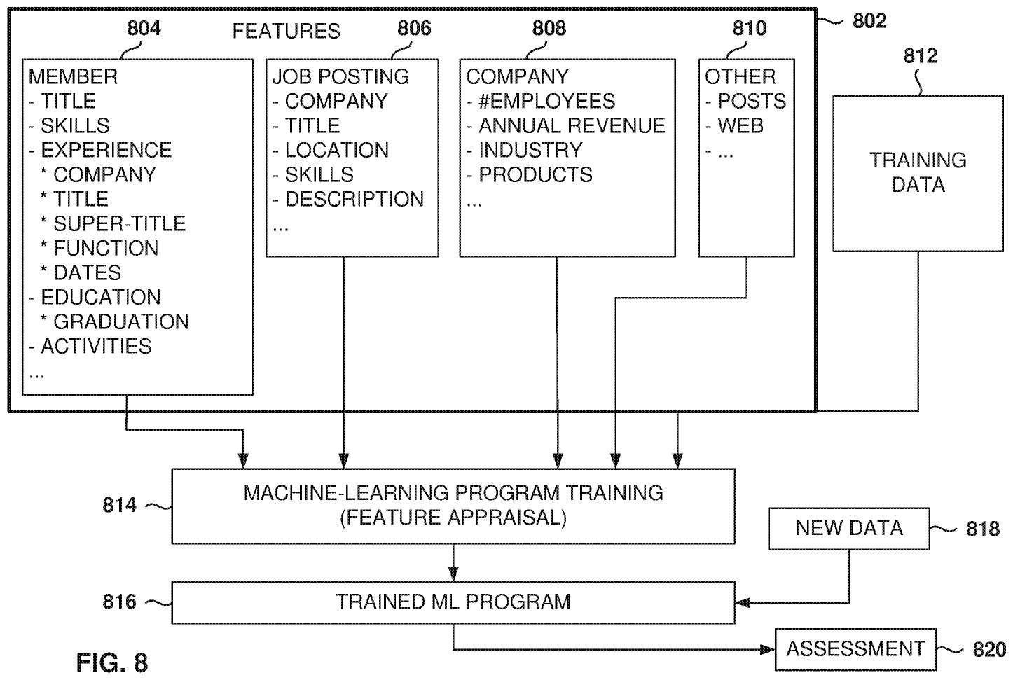

The QJS flavor 132 sends the member ID and the job IDs to the QJS scorer 510 and the QJS scorer 510 calculates the matching score for the QJS flavor 132 based on the member 136's profile and the job characteristics. In some example embodiments, a machine-learning model is used to calculate the matching score. More details are provided below with reference to FIG. 8 for using the machine-learning model to calculate the matching score. The QJS scorer 510 returns the matching scores for the job IDs.

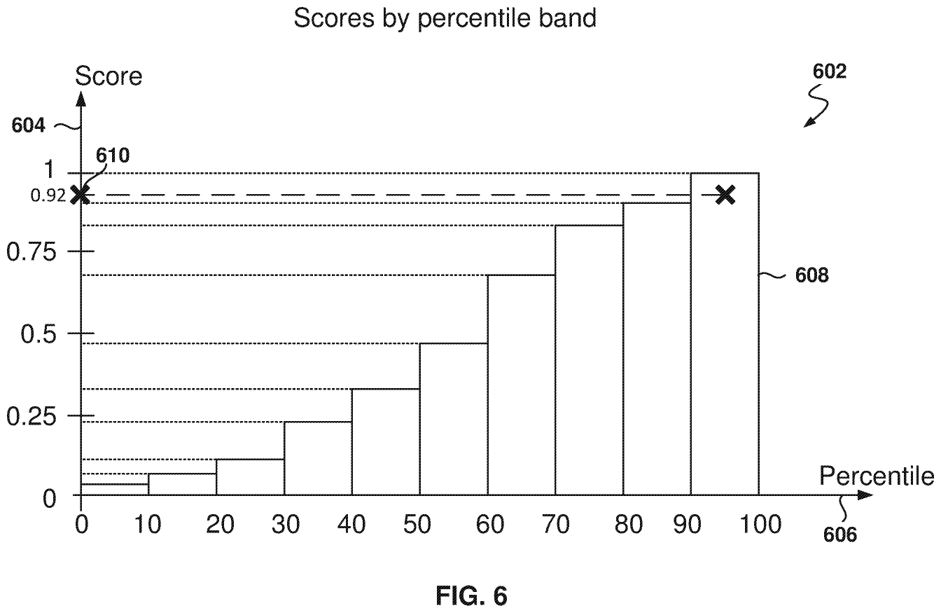

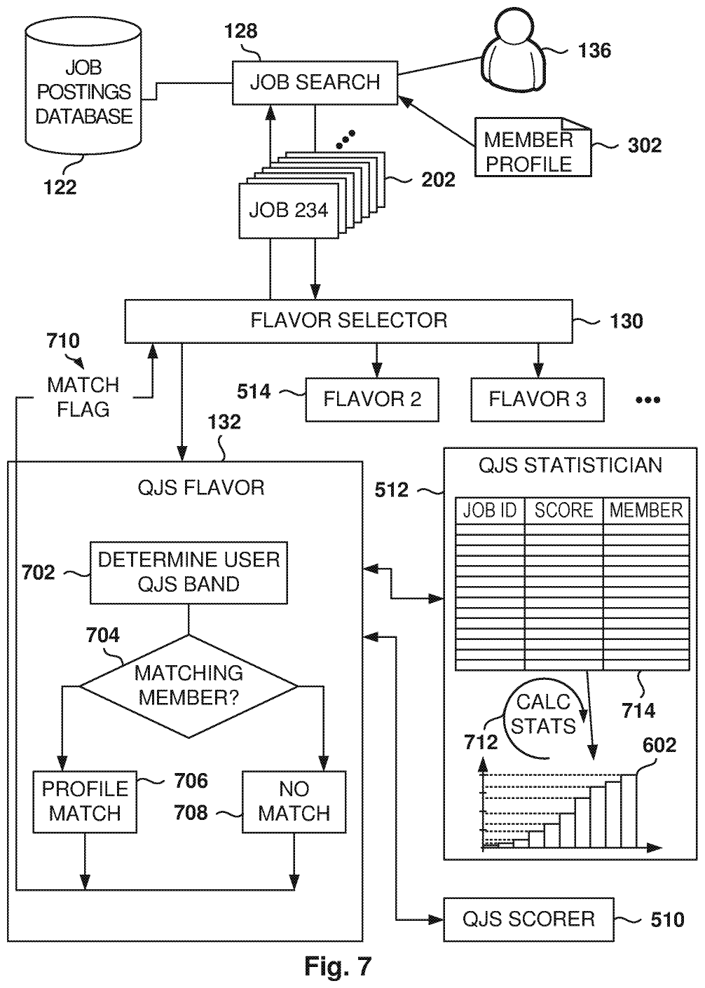

The QJS statistician 512 tracks the matching scores obtained by user when they view the job posting and calculates statistical parameters to assist in the determination of when a member 136 is a good match for the job posting. That is, the determination of when the member 136 is a good match is based on a comparison of the member 136 with other users of the online service. A good match means that the member 136 has a high score when compared to other members 136, and a bad match (e.g., low matching score) means that there are many other members 136 that have better matching scores than the member 136. More details are provided below with reference to FIGS. 6 and 7. The QJS statistician 512 receives the job identifiers from the QJS flavor 132 and returns information that maps the job IDs to histogram matches.

In some example embodiments, the QJS scorer 510 calculates the matching score utilizing a machine-learning model, as the one described below with reference to FIG. 8, that uses features related to the member 136, the job posting, the company 403 posting the job posting, and others.

Once the QJS flavor 132 gets the matching scores and the histogram of the matching scores, the QJS 132 determines if each of the job postings is a good match for the user, e.g., the QJS flavor 132 is selected for each of the job IDs. The QJS flavor 132 then returns the member 136's rank for each of the job IDs. The flavor selector 130 then selects the top flavor for presenting in the user interface 200 and returns the selected flavor to the job search module 128 via the job search API 504.

In some example embodiments, the data returned by the QJS flavor 132 is defined as follows:

TABLE 1

| Field Name | Type | Optional | Description |
|---|---|---|---|
| member | MemberUrn | N | The urn of the member. |
| job | JobUm | N | The urn of the job. |
| category | ApplicantRankScoreCategory | N | The category of applicant |
| | | | ranker score and percentile. |
| percentile | float | N | The percentile of score ranked |
| | | | among all applicants. |
| | | | The range is [0, 1]. |
| score | float | N | The applicant ranker score. |
| | | | The range is [0, 1]. |
| rankingApplicantCount | int | Y | Total number of applicants |
| | | | used to compute ranking. |
| applicantCount | int | N | Total number of applicants. |
| matchResult | JobPostingMemberMatchResult | Y | An enum indicating if this |
| | | | (member, job) pair is a good |
| | | | match. |

The JobPostingMemberMatchResult is an enum indicating the result of matching a (member, job) pair, which could be a match, no match, or undefined when there is not enough data to determine if the member 136 is a good match for the job ID.

In some example embodiments, the ApplicantRankScoreCategory is an existing list (e.g., enum) to indicate the category of applicant ranker score and percentile:

TABLE 2

| Enum Name | Description |
|---|---|
| SKILL_SET | The category of applicants skills. |
| PAST_POSITION | The category of applicant |
| | past experience. |
| CURRENT_POSITION | The category of applicant |
| | current experience |
| OVERALL | The overall category. |
| QUALITY_APPLICANT_OVERALL | Rank based on the QJS |
| | relevance model. |

It is noted that the embodiments illustrated in FIG. 5 are examples and do not describe every possible embodiment. Other embodiments may utilize different modules, combine the functionality of several modules into a single module, etc. The embodiments illustrated in FIG. 5 should therefore not be interpreted to be exclusive or limiting, but rather illustrative.

FIG. 6 is a histogram of matching scores for members 136 that view a job posting 202-205, according to some example embodiments. The QJS statistician 512 keeps a table for each job ID with an entry for each user that viewed the job posting and the matching score that the user received. The QJS statistician 512 then calculates statistics in order to compare how a given member 136 compares to other members 136 of the social networking service regarding the particular job posting. The QJS statistician 512 recalculates the statistics periodically, such as every day, every week, every couple of hours, etc.

Initially, there may not be enough data for calculating statistics, so the QJS flavor 132 will not be triggered until a predetermined number of members 136 have seen the job ID, such as 100 users, 500 users, etc.

The QJS statistician 512 then returns statistical values to the QJS flavor 132 so the QJS flavor 132 can determine if the flavor will be selected for the member 136 and the job ID. In other example embodiments, the QJS statistician 512 may just send a threshold score back to the QJS flavor 132, where the threshold score determines activation of the flavor 514. For example, the threshold score may be that matching score for the percentile that determines activation of the flavor, such as the 90^{th} percentile, the 80^{th} percentile, or some other percentile as defined by the system administrator. The threshold score may be fine-tuned by the system in order to determine if more or less users are shown that matching message 208.

Percentile chart 602 illustrates an embodiment for calculating histogram information. The percentile chart 602 includes a horizontal axis 606 for the percentile values and a vertical axis 604 for the matching scores. In some example embodiment, the percentiles are grouped in bands and the matching score is determined based on the band where a particular match falls. For example, the percentile bands may be defined by groups of 10, but other values maybe used. This way, the percentile bands will go from 0 to 10, 10 to 20, 20 to 30, etc.

Percentile chart 602 shows each of the bands for the matching scores, and each band has an associated low boundary matching score and high boundary matching score. In this example, the top band 608 of percentiles above 90^{th} percentile would correspond to matching scores between 0.89 and 1. Therefore, a user with a matching score 610 of 0.92 would fall in the top percentile band 608. If the top two bands are selected for triggering the QJS flavor 132, then the user with the matching score of 0.92 would see the message indicating the good match with the job posting.

Further, if the top 2 percentile bands are selected, then the flavor would be triggered for users with matching score above 0.84, which is the low boundary for the band between the 80^{th} percentile and the 90^{th} percentile.

FIG. 7 illustrates the process for determining if the qualified-job-seeker (QJS) flavor 132 is selected for presentation in the user interface, according to some example embodiments. As discussed above, the job search 128 searches the job postings database 122 in response to a member 136's query and the result is a plurality of job postings 202 that are passed to the flavor selector 130 for determining which flavors 514, if any, will be selected for presenting in the user interface 200.

The QJS statistician 512 keeps a table 714 with job IDs, matching scores, and user IDs. Based on the data in table 714, the QJS statistician 512 calculates statistics 712 to generate statistical data, such as histogram data 602, for each job ID.

The QJS flavor 132 determines, at operation 702, the histogram band (also referred to as QJS band) for the member 136 and job ID based on the score provided by QJS scorer 510 and the statistical data provided by the QJS statistician 512.

At operation 704, the QJS flavor 132 determines if the member 136 is a match of the QJS flavor 706 or if the member 136 is not a match 708. The status of the match 708 is returned in a match flag 710 to the flavor selector 130, which then determines which flavor to select for the user and the job posting based on the scores from the different flavors 514.

FIG. 8 illustrates the training and use of a machine-learning program, according to some example embodiments. In some example embodiments, machine-learning programs (MLP), also referred to as machine-learning algorithms or tools, are utilized to perform operations associated with searches, such as job searches.

Machine learning is a field of study that gives computers the ability to learn without being explicitly programmed. Machine learning explores the study and construction of algorithms, also referred to herein as tools, that may learn from existing data and make predictions about new data. Such machine-learning tools operate by building a model from example training data 812 in order to make data-driven predictions or decisions expressed as outputs or assessments 820. Although example embodiments are presented with respect to a few machine-learning tools, the principles presented herein may be applied to other machine-learning tools.

In some example embodiments, different machine-learning tools may be used. For example, Logistic Regression (LR), Naive-Bayes, Random Forest (RF), neural networks (NN), matrix factorization, and Support Vector Machines (SVM) tools may be used for classifying or scoring job postings 202-205.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number). The machine-learning algorithms utilize the training data 812 to find correlations among identified features 802 that affect the outcome.

The machine-learning algorithms utilize features 802 for analyzing the data 812 to generate assessments 820. A feature 802 is an individual measurable property of a phenomenon being observed. The concept of feature 802 is related to that of an explanatory variable used in statistical techniques such as linear regression. Choosing informative, discriminating, and independent features 802 is important for effective operation of the MLP in pattern recognition, classification, and regression. Features 802 may be of different types, such as numeric, strings, and graphs.

In one example embodiment, the features 802 may be of different types and may include one or more of member features 804, job posting features 806, company features 808, and other features 810. The member features 804 may include one or more of the data in the member profile 302 such as title, skills 416, experience 308, education 310, activities, endorsements, and the like. The job posting features 806 may include any data related to the job posting, and the company features 808 may include any data related to the company 403 posting the job posting. In some example embodiments, other features 810 may be included, such as post data, message data, web data, and the like.

The machine-learning algorithms utilize the training data 812 to find correlations among the identified features 802 that affect the outcome or assessment 820. In some example embodiments, the training data 812 includes known data for one or more identified features 802 and one or more outcomes, such as job postings 202 searched by members 136, job suggestions selected for reviews, members 136 changing companies, members 136 adding social connections, members' 136 activities online, and the like.

With the training data 812 and the identified features 802, the machine-learning tool is trained at operation 814. The machine-learning tool appraises the value of the features 802 as they correlate to the training data 812. The result of the training is the trained machine-learning program 816.

When the machine-learning program 816 is used to perform an assessment 820, new data 818 is provided as an input to the trained machine-learning program 816, and the machine-learning program 816 generates the assessment 820 as output. For example, when a member 136 performs a job search 128, a machine-learning program 816, trained with social network data, utilizes the member data 804 and the job data 806, from the job postings 202 in the database, to search for job postings 202 that match the member 136's profile and activity.

In some example embodiments, online service data is used for training, where the online service data includes, at least, job postings 202-205 presented to members 136, when members 136 apply or clicks on the job postings 202 for viewing, when companies send communications to candidates regarding a job, when applicants get hired.

In some example embodiments, the machine-learning program 816 may be utilized to determine the matching score discussed above. In another example embodiments, the machine-learning program 816 may be utilized determine which job postings 202 are selected in response to the user query.

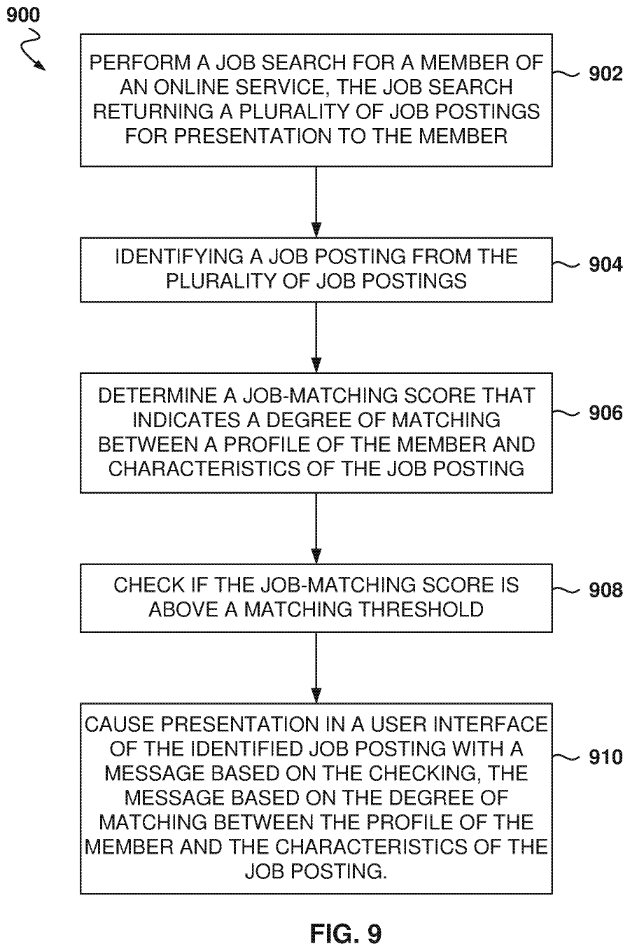

FIG. 9 is a flowchart of a method 900 for determining presentation options, associated with a job posting 202-205, related to how well the member 136's profile matches the job posting characteristics. While the various operations in this flowchart are presented and described sequentially, one of ordinary skill will appreciate that some or all of the operations may be executed in a different order, be combined or omitted, or be executed in parallel.

At operation 902, one or more processors perform a job search 128 for a member 136 of an online service, the job search 128 returning a plurality of job postings 202 for presentation to the member 136. From operation 902, the method 900 flows to operation 904 where that one or more processors identify a job posting from the plurality of job postings.

At operation 906, the one or more processors determine a job-matching score that indicates a degree of matching between a profile of the member 136 and characteristics of the identified job posting.

From operation 906, the method 900 flows to operation 908 where the one or more processors check if the job-matching score is above a matching threshold. Operation 908 is for causing presentation in a user interface 200 of the identified job posting with a message based on the checking, where the message is based on the degree of matching between the profile of the member 136 and the characteristics of the identified job posting.

In one example, the method 900 further comprises storing member 136 job-matching scores for members 136 that view the identified job posting, and calculating one or more statistical values for the identified job posting based on the stored member job-matching scores. The statistical values include a plurality of percentile bands for the member job-matching scores, each band associated with member job-matching scores between a low value and a high value.

In one example, the method 900 further comprises calculating the matching threshold based on the plurality of percentile bands, the matching threshold corresponding to the low value of one from the plurality of percentile bands.

In one example, the message indicates that the profile of the member 136 matches the characteristics of the identified job posting.

In one example, causing presentation in the user interface of the identified job posting comprises posting the message with the identified job posting when the job-matching score is above the matching threshold, and omitting the message with the identified job posting when the job-matching score is not above the matching threshold.

In one example, the message includes the job-matching score.

In one example, the method 900 further comprises determining, by a plurality of flavor modules, presentation data for the identified job posting, and determining how the identified job posting is presented in the user interface based on the presentation data for the plurality of flavor modules.

In one example, the characteristics of the identified job posting include job title 402, company 403, location 406, job description 415, and skills 416 required, wherein the profile of the member 136 includes job experience 308, skills 416, title, and education 310.

In one example, the degree of matching is based on how much the profile of the member 136 covers requirements for the identified job posting defined by the characteristics of the identified job posting.

In one example, determining the job-matching score comprises utilizing a machine-learning model to calculate the job-matching score, the machine-learning model utilizing a plurality of features 802 associated with the profile of the member 136, the characteristics of the identified job posting, and a company 403 posting the identified job posting.

Another general aspect is for a system that includes a memory comprising instructions and one or more computer processors. The instructions, when executed by the one or more computer processors, cause the one or more computer processors to perform operations comprising: performing a job search 128 for a member 136 of an online service, the job search 128 returning a plurality of job postings 202 for presentation to the member 136; identifying a job posting from the plurality of job postings; determining a job-matching score that indicates a degree of matching between a profile of the member 136 and characteristics of the identified job posting; checking if the job-matching score is above a matching threshold; and causing presentation in a user interface 200 of the identified job posting with a message based on the checking, the message based on the degree of matching between the profile of the member 136 and the characteristics of the identified job posting.

In yet another general aspect, a machine-readable storage medium (e.g., a non-transitory storage medium) includes instructions that, when executed by a machine, cause the machine to perform operations comprising: performing a job search 128 for a member 136 of an online service, the job search 128 returning a plurality of job postings 202 for presentation to the member 136; identifying a job posting from the plurality of job postings; determining a job-matching score that indicates a degree of matching between a profile of the member 136 and characteristics of the identified job posting; checking if the job-matching score is above a matching threshold; and causing presentation in a user interface 200 of the identified job posting with a message based on the checking, the message based on the degree of matching between the profile of the member 136 and the characteristics of the identified job posting.

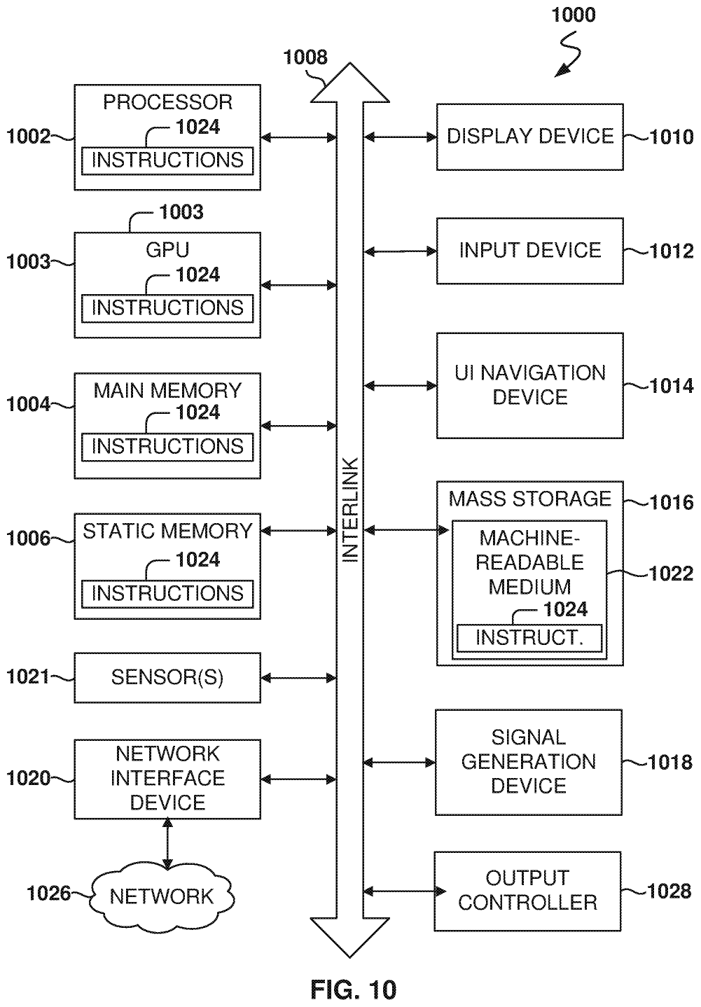

FIG. 10 is a block diagram illustrating an example of a machine 1000 upon or by which one or more example process embodiments described herein may be implemented or controlled. In alternative embodiments, the machine 1000 may operate as a standalone device or may be connected (e.g., networked) to other machines. In a networked deployment, the machine 1000 may operate in the capacity of a server machine, a client machine, or both in server-client network environments. In an example, the machine 1000 may act as a peer machine in a peer-to-peer (P2P) (or other distributed) network environment. Further, while only a single machine 1000 is illustrated, the term “machine” shall also be taken to include any collection of machines 1000 that individually or jointly execute a set (or multiple sets) of instructions to perform any one or more of the methodologies discussed herein, such as via cloud computing, software as a service (SaaS), or other computer cluster configurations.

Examples, as described herein, may include, or may operate by, logic, a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, by moveable placement of invariant massed particles, etc.) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 1000 may include a hardware processor 1002 (e.g., a central processing unit (CPU), a hardware processor core, or any combination thereof), a graphics processing unit (GPU) 1003, a main memory 1004, and a static memory 1006, some or all of which may communicate with each other via an interlink (e.g., bus) 1008. The machine 1000 may further include a display device 1010, an alphanumeric input device 1012 (e.g., a keyboard), and a user interface (UI) navigation device 1014 (e.g., a mouse). In an example, the display device 1010, alphanumeric input device 1012, and UI navigation device 1014 may be a touch screen display. The machine 1000 may additionally include a mass storage device (e.g., drive unit) 1016, a signal generation device 1018 (e.g., a speaker), a network interface device 1020, and one or more sensors 1021, such as a Global Positioning System (GPS) sensor, compass, accelerometer, or another sensor. The machine 1000 may include an output controller 1028, such as a serial (e.g., universal serial bus (USB)), parallel, or other wired or wireless (e.g., infrared (IR), near field communication (NFC), etc.) connection to communicate with or control one or more peripheral devices (e.g., a printer, card reader, etc.).

The mass storage device 1016 may include a machine-readable medium 1022 on which is stored one or more sets of data structures or instructions 1024 (e.g., software) embodying or utilized by any one or more of the techniques or functions described herein. The instructions 1024 may also reside, completely or at least partially, within the main memory 1004, within the static memory 1006, within the hardware processor 1002, or within the GPU 1003 during execution thereof by the machine 1000. In an example, one or any combination of the hardware processor 1002, the GPU 1003, the main memory 1004, the static memory 1006, or the mass storage device 1016 may constitute machine-readable media 1022.

While the machine-readable medium 1022 is illustrated as a single medium, the term “machine-readable medium” may include a single medium, or multiple media, (e.g., a centralized or distributed database, and/or associated caches and servers) configured to store the one or more instructions 1024.

The term “machine-readable medium” may include any medium that is capable of storing, encoding, or carrying instructions 1024 for execution by the machine 1000 and that cause the machine 1000 to perform any one or more of the techniques of the present disclosure, or that is capable of storing, encoding, or carrying data structures used by or associated with such instructions 1024. Non-limiting machine-readable medium 1022 examples may include solid-state memories, and optical and magnetic media. In an example, a massed machine-readable medium comprises a machine-readable medium 1022 with a plurality of particles having invariant (e.g., rest) mass. Accordingly, massed machine-readable media are not transitory propagating signals. Specific examples of massed machine-readable media may include non-volatile memory, such as semiconductor memory devices (e.g., electrically programmable read-only memory (EPROM), electrically erasable programmable read-only memory (EEPROM)) and flash memory devices; magnetic disks, such as internal hard disks and removable disks; magneto-optical disks; and CD-ROM and DVD-ROM disks.

The instructions 1024 may further be transmitted or received over a communications network 1026 using a transmission medium via the network interface device 1020.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
performing, by one or more processors, a job search for a member of an online service, the job search returning a plurality of job postings for presentation to the member;
identifying a job posting from the plurality of job postings;
determining, by the one or more processors, a job-matching score that indicates a degree of matching between a profile of the member and characteristics of the identified job posting;
checking, by the one or more processors, if the job-matching score is above a matching threshold; and
causing, by the one or more processors, presentation in a user interface of the identified job posting with a message based on the checking, the message based on the degree of matching between the profile of the member and the characteristics of the identified job posting.

2. The method as recited in claim 1, further comprising:
storing member job-matching scores for members that view the identified job posting; and
calculating one or more statistical values for the identified job posting based on the stored member job-matching scores, the statistical values including a plurality of percentile bands for the member job-matching scores, each band associated with member job-matching scores between a low value and a high value.

3. The method as recited in claim 2, further comprising:
calculating the matching threshold based on the plurality of percentile bands, the matching threshold corresponding to the low value of one percentile band from the plurality of percentile bands.

4. The method as recited in claim 1, wherein the message indicates that the profile of the member matches the characteristics of the identified job posting.

5. The method as recited in claim 1, wherein causing presentation in the user interface of the identified job posting comprises:
posting the message with the identified job posting when the job-matching score is above the matching threshold; or
omitting the message with the identified job posting when the job-matching score is not above the matching threshold.

6. The method as recited in claim 1, wherein the message includes the job-matching score.

7. The method as recited in claim 1, further comprising:
determining, by a plurality of flavor modules, presentation data for the identified job posting; and
determining how the identified job posting is presented in the user interface based on the presentation data for the plurality of flavor modules.

8. The method as recited in claim 1, wherein the characteristics of the identified job posting include job title, company, location, job description, and skills required, wherein the profile of the member includes job experience, skills, title, and education.

9. The method as recited in claim 1, wherein the degree of matching is based on how much the profile of the member matches requirements for the identified job posting defined by the characteristics of the identified job posting.

10. The method as recited in claim 1, wherein determining the job-matching score comprises:
utilizing a machine-learning model to calculate the job-matching score, the machine-learning model utilizing a plurality of features associated with the profile of the member, the characteristics of the identified job posting, and a company on behalf of which the job posting has been posted.

11. A system comprising:
a memory comprising instructions; and
one or more computer processors, wherein the instructions, when executed by the one or more computer processors, cause the one or more computer processors to perform operations comprising:
performing a job search for a member of an online service, the job search returning a plurality of job postings for presentation to the member;
identifying a job posting from the plurality of job postings;
determining a job-matching score that indicates a degree of matching between a profile of the member and characteristics of the identified job posting;
checking if the job-matching score is above a matching threshold; and
causing presentation, in a user interface, of the identified job posting with a message based on the checking, the message based on the degree of matching between the profile of the member and the characteristics of the identified job posting.

12. The system as recited in claim 11, wherein the instructions further cause the one or more computer processors to perform operations comprising:
storing member job-matching scores for members that view the identified job posting; and
calculating one or more statistical values for the identified job posting based on the stored member job-matching scores, the statistical values including a plurality of percentile bands for the member job-matching scores, each band associated with member job-matching scores between a low value and a high value.

13. The system as recited in claim 12, wherein the instructions further cause the one or more computer processors to perform operations comprising:
calculating the matching threshold based on the plurality of percentile bands, the matching threshold corresponding to the low value of one from the plurality of percentile bands.

14. The system as recited in claim 11, wherein the message indicates that the profile of the member matches the characteristics of the identified job posting.

15. The system as recited in claim 11, wherein causing presentation in the user interface of the identified job posting comprises:
posting the message with the identified job posting when the job-matching score is above the matching threshold; or
omitting the message with the identified job posting when the job-matching score is not above the matching threshold.

16. A non-transitory machine-readable storage medium including instructions that, when executed by a machine, cause the machine to perform operations comprising:
performing a job search for a member of an online service, the job search returning a plurality of job postings for presentation to the member;
identifying a job posting from the plurality of job postings;
determining a job-matching score that indicates a degree of matching between a profile of the member and characteristics of the identified job posting;
checking if the job-matching score is above a matching threshold; and
causing presentation in a user interface of the identified job posting with a message based on the checking, the message based on the degree of matching between the profile of the member and the characteristics of the identified job posting.

17. The non-transitory machine-readable storage medium as recited in claim 16, wherein the machine further performs operations comprising:
storing member job-matching scores for members that view the identified job posting; and
calculating one or more statistical values for the identified job posting based on the stored member job-matching scores, the statistical values including a plurality of percentile bands for the member job-matching scores, each band associated with member job-matching scores between a low value and a high value.

18. The non-transitory machine-readable storage medium as recited in claim 17, wherein the machine further performs operations comprising:
calculating the matching threshold based on the plurality of percentile bands, the matching threshold corresponding to the low value of one from the plurality of percentile bands.

19. The non-transitory machine-readable storage medium as recited in claim 16, wherein the message indicates that the profile of the member matches the characteristics of the identified job posting.

20. The non-transitory machine-readable storage medium as recited in claim 16, wherein causing presentation in the user interface of the identified job posting comprises:
posting the message with the identified job posting when the job-matching score is above the matching threshold; or
omitting the message with the identified job posting when the job-matching score is not above the matching threshold.
